(19) United States
(12) Patent Application Publication
(10) Pub. No.: US 2006/0217847 A1
(43) Pub. Date: Sep. 28, 2006

(54) Power sourcing unit for power over ethernet system

(75) Inventor: John Anderson, Eden Prairie, MN (US)

Correspondence Address: MERCHANT & GOULD PC, P.O. BOX 2903, MINNEAPOLIS, MN, 55402-0903, US

(73) Assignee: ADC Telecommunications, Inc., Eden Prairie, MN (US)

(21) Appl. No.: 11/091,893

(22) Filed: Mar. 28, 2005

(51) Int. Cl. G05D 11/00

(52) U.S. Cl. 700/286

(57) ABSTRACT

A circuit board for a power sourcing unit for a power over ethernet system. The circuit board includes a power over ethernet controller. The circuit board also includes a switch connected to the power over ethernet controller. The switch switches a polarity of an output voltage controlled by the power over ethernet controller. The circuit board can also include a microcontroller to control a state of the switch. The switch can include a first state for a first output voltage polarity, and a second state for a second output voltage polarity that is opposite to that of the first state. The switch can be a latching relay. The circuit board can include a plurality of relays, one relay for each jack of the power sourcing unit. The circuit board can also include a second switch to switch transmit and receive pairs controlled by the power over ethernet controller.

### TECHNICAL FIELD

The present invention relates to systems and methods for the distribution of data and power over a local area network, and, more particularly, to power over ethernet power sourcing units.

### BACKGROUND

Interest in power over ethernet technology has increased with the adoption of the power over ethernet IEEE 802.3af standard in June of 2003. Generally, power over ethernet technology allows standard ethernet cables to carry not only data signals, but also power to devices (referred to as “powered devices”) connected to the cables. In this manner, power can be provided by the ethernet cable itself, rather than requiring a separate source of power for the powered devices.

The standard requires a power sourcing unit, which supplies up to 15.4 watts of power (at 48 volts) to one or more powered devices. The standard utilizes pairs 1/2 and 3/6 of the eight-pin ethernet cable as respective transmit and receiver pairs. The standard utilizes pairs 1/2 and 3/6, or pairs 4/5 and 7/8, for power transfer. The voltage applied to these pairs can be of either polarity.

To avoid damaging non-compliant devices that may be connected to the power over ethernet system, the standard specifies a method for detecting compliant devices by applying a small, current-limited voltage to check for the presence of a 25k ohm impedance in the connected device. Only if the power sourcing unit detects this impedance is the full 48 volts applied.

There are many potential applications for power over ethernet technology. For example, wireless access points can be placed at desired locations throughout a building without requiring a separate source of power. Another potential application includes internet protocol (IP) telephones, for which a central power supply with a backup uninterrupted power supply (UPS) is desirable. Other applications for which this technology may be desirable include IP cameras, security badge readers, etc.

The advantages associated with power over ethernet technology can include: reduced cabling costs, because both power and data are provided over a single ethernet cable; increased reliability, because a centralized power source can utilize an UPS to guarantee uninterrupted power to all powered devices; and increased network management, to allow powered devices to be monitored and controlled remotely.

Before ratification of the IEEE 802.3af standard in June of 2003, equipment providers marketed their own power sourcing units and powered devices. Some of these pre-standard powered devices (referred to as “legacy devices”) do not comply with the IEEE 802.3af standard. For example, some legacy devices require a specified voltage polarity to power the legacy devices, and this specified voltage polarity may be reversed from that provided by a power sourcing unit. Other legacy devices have transmit and receive pairs that are reversed with respect to the standard.

Failure to account for these variances in legacy devices can, in best case scenarios, result in failure to power the legacy devices and/or a failure in the connectivity to legacy devices, and can, in worst case scenarios, result in the shorting out and damage of the legacy devices. In order to account for these variances in legacy devices, it is necessary to utilize special patch cords to connect legacy devices to power sourcing units. For example, special patch cords can be provided to reverse voltage polarity and/or to reverse the transmit/receive pairs. It can be difficult and cumbersome to use these special patch cords, especially when a mixture of both compliant powered devices and legacy devices are connected to the same power sourcing unit.

It is therefore desirable to provide enhanced functionality for the power sourcing units of power over ethernet systems to allow power sourcing units to power both legacy devices and devices complying with the IEEE 802.3af standard.

### SUMMARY

Embodiments of the present invention are directed to systems and methods for the distribution of data signals and power over a local area network, and, more particularly, to power over ethernet power sourcing units.

In one embodiment, a circuit board for a power sourcing unit for a power over ethernet system includes a power over ethernet controller, and a switch connected to the power over ethernet controller, wherein the switch switches a polarity of an output voltage controlled by the power over ethernet controller.

In another embodiment, a power sourcing unit for a power over ethernet system includes a chassis, a power supply positioned in the chassis, and a plurality of jacks. The power sourcing unit also includes a printed circuit board coupled to the power supply and the plurality of jacks, the printed circuit board including a controller and a plurality of latching relays, at least one latching relay for each of the jacks, a state of each latching relay being controlled by the controller to switch a polarity of an output voltage from the power supply provided to a corresponding one of the jacks.

In yet another embodiment, a method for powering devices using an ethernet connection includes: providing a power sourcing unit including a power over ethernet controller, and a switch connected to the power over ethernet controller; and switching the switch to change a polarity of an output voltage controlled by the power over ethernet controller when a legacy device is connected to the power sourcing unit.

The above summary of embodiments made in accordance with the present invention is not intended to describe each disclosed embodiment or every implementation of the present invention. The figures and the detailed description that follow more particularly exemplify embodiments of the invention. While certain embodiments will be illustrated and described, the invention is not limited to use in such embodiments.

### BRIEF DESCRIPTION OF THE DRAWINGS

FIG. 1 is a front perspective view of an example power sourcing unit of a power over ethernet system.

FIG. 2 is a back perspective view of the power sourcing unit of FIG. 1.

FIG. 3 is a front perspective view of the power sourcing unit of FIG. 1 with a cover removed.

FIG. 4 is a schematic view of example components mounted on the circuit board of FIG. 3.

FIG. 5 is a schematic view of an example power over ethernet system including a power sourcing unit and a powered device.

FIG. 6 is a schematic view of an example connection between a power sourcing unit and a powered device.

FIG. 7 is a schematic view of another embodiment of example components mounted on a circuit board of a power sourcing unit.

FIG. 8 is a schematic view of a latching relay of FIG. 7 in a second state.

### DETAILED DESCRIPTION OF THE PREFERRED EMBODIMENT

Embodiments of the present invention are directed to systems and methods for the distribution of data signals and power over a local area network, and, more particularly, to power over ethernet power sourcing units. Example embodiments illustrated herein are power sourcing units made in compliance with the IEEE Std. 802.3af™-2003, which is incorporated by reference herein in its entirety. The power sourcing units described herein are configured to deliver both data signals and power over an ethernet cable to a powered device.

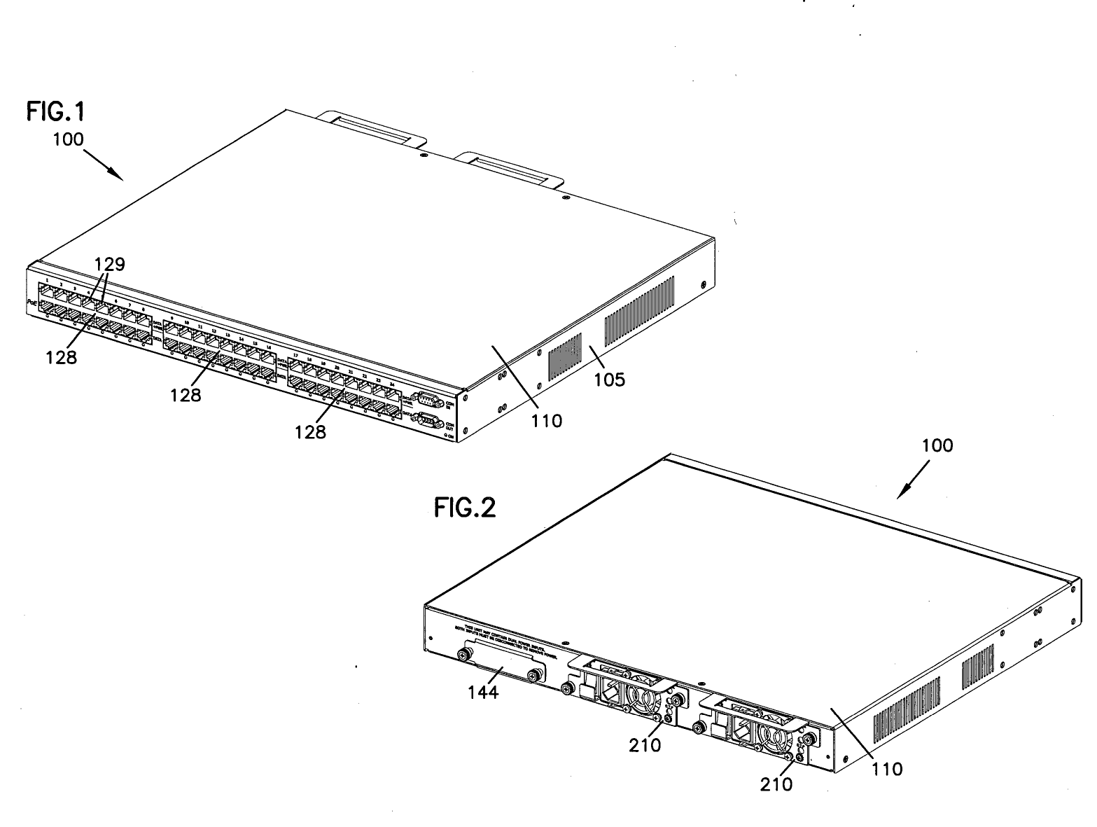

Referring now to FIGS. 1 and 2, an example embodiment of a power sourcing unit 100 of a power over ethernet system is shown. The unit 100 generally includes a chassis 105, a cover 110, and a plurality of port modules 128, each including a plurality of jacks 129.

In the example shown, each of the jacks 129 of each port module 128 is an RJ-45 jack, although other types of jacks can be used. The jacks 129 in each port module 128 are arranged vertically in pairs so that an ethernet cable carrying a data signal from, for example, an ethernet switch can be coupled to a lower jack 129, and an ethernet cable to, for example, a powered device can be coupled to the corresponding upper jack 129 to carry the data signal and power injected by the unit 100 to a powered device. See FIG. 5 described below. A back of the unit 100 includes a CPU cover 144 and dual power supplies 210.

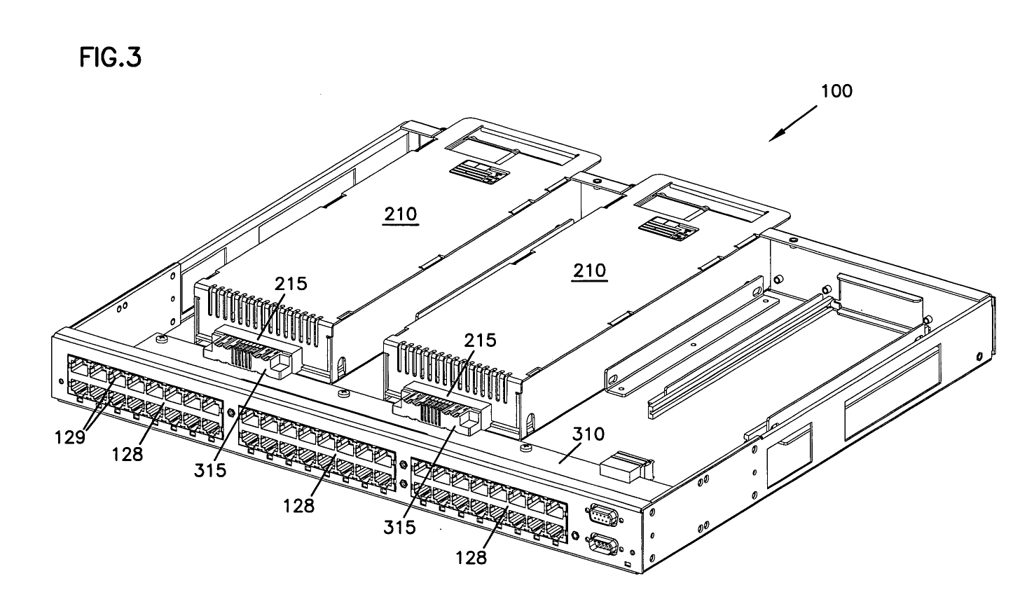

Referring now to FIG. 3, the internal components of the unit 100 are illustrated. Unit 100 generally includes power supplies 210 and a printed circuit board 310. (An optional CPU line card is not shown.)

The power supplies 210 convert an alternating current (AC) power source to direct current (DC) to power the unit 100 and any powered devices coupled to the unit 100. In the example, each power supply 210 is a power supply with product number PALS400 manufactured by Power-One, Inc. of Camarillo, Calif. In the example embodiment, the power supplies 210 convert the AC power source to provide 48 volts DC to the printed circuit board 310. Each power supply 210 includes a connector 215 that mates with a connector 315 mounted on the printed circuit board 310 to couple the power supply 210 to the printed circuit board 310.

In the example shown, power supplies 210 are redundant and “hot-swappable,” so that each power supply 210 can individually power unit 100. For example, one power supply 210 can be removed while the remaining power supply 210 continues to power unit 100. In other embodiments, only a single power supply can be used.

The printed circuit board 310 includes a plurality of logic components and a plurality of tracings etched thereon (not shown) to electrically connect the various components mounted on the circuit board 310. Components on the printed circuit board 310 are powered through the conversion of the 48 volts DC provided by one or more of the power supplies 210 to approximately 3.3 volts DC. In addition, the printed circuit board 310 delivers up to 48 volts DC to each jack 129 in each port module 128 that is connected to a powered device.

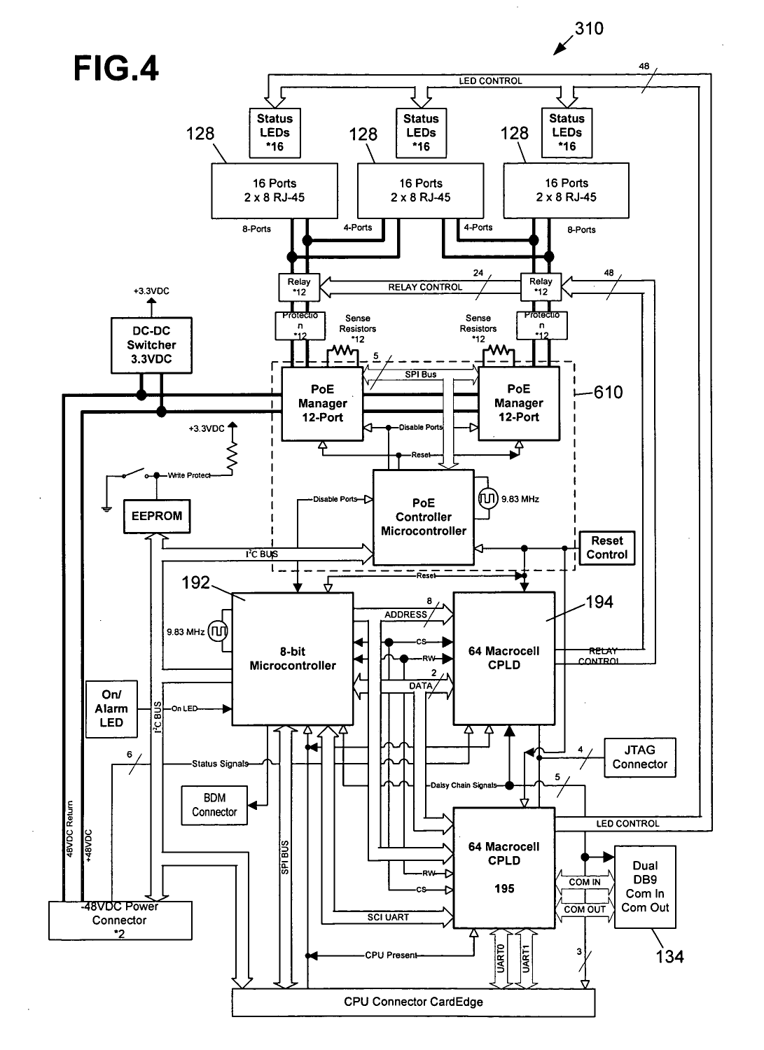

Referring now to FIG. 4, the interconnection of example components mounted on printed circuit board 310 is shown. Generally, an 8-bit microcontroller 192 processes and controls other components on the printed circuit board 310 and, for example, communicates with power supplies 210 and CPU line card, if present. In addition, a Complex Programmable Logic Device (CPLD) 195 controls various aspects of the power sourcing unit 100 such as, for example, various LEDs and multiplex serial communication signals to the CPU line card and microcontroller 192. Also included is a COM module 134 for communication with other components such as, for example, other power sourcing units and/or a device used to access and program power sourcing unit 100.

In example embodiments, as shown in FIG. 5, power sourcing unit 100 can be placed between an ethernet switch 565 and one or more powered devices 570 (only one device 570 is shown in FIG. 5 for purposes of clarity) to supply data signals from the ethernet switch 565, as well as power from unit 100, to the powered device 570. Power sourcing unit 100 shown in FIG. 5 can be referred to as a mid-span power sourcing unit because it is placed between ethernet switch 565 and powered device 570. Another type of power sourcing unit is a data terminal equipment (DTE) power sourcing unit, which combines the ethernet switch 565 and power sourcing unit 100 into a single unit.

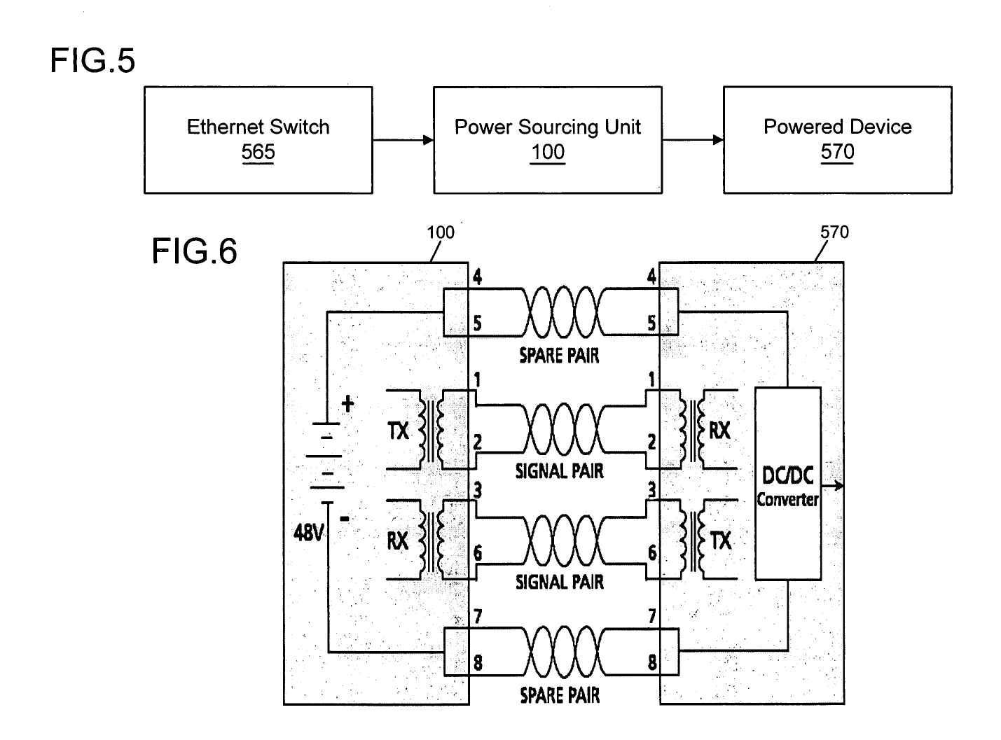

As shown in FIG. 6, in one embodiment power is sent over wire pairs 4/5, 7/8 and data is transmitted over pairs 1/2, 3/6 of an eight-pin ethernet cable. (This is sometimes referred to as powering scheme “Alternative B” used for mid-span configurations.) In other embodiments, power and data can be transmitted over the same wire pairs (e.g., wire pairs 1/2, 3/6—this is sometimes referred to as powering scheme “Alternative A” used for DTE configurations).

Additional details regarding an example power sourcing unit configured in a manner similar to that of power sourcing unit 100 described above can be found in U.S. patent application Ser. No. 10/843,216, filed on May 11, 2004 and entitled “Power Sourcing Unit for Power Over Ethernet System,” the entirety of which is hereby incorporated by reference.

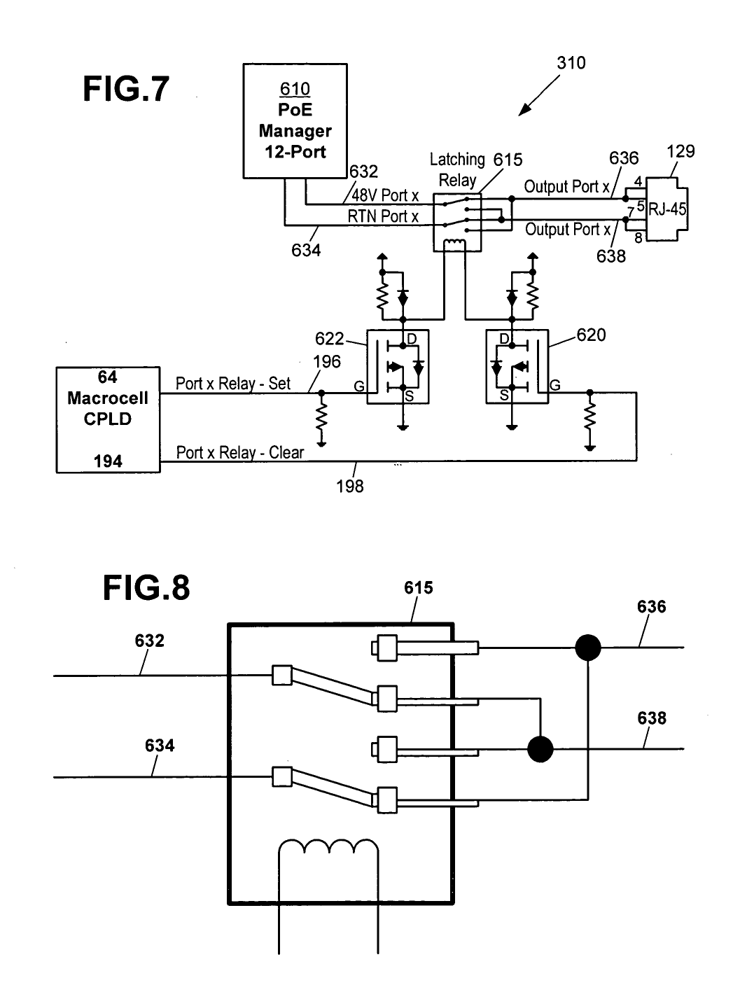

Referring now to FIGS. 4 and 7, additional details regarding the components of circuit board 310 are shown and described. Circuit board 310 includes CPLD 194. Also included is a power over ethernet (PoE) controller 610 that performs many of the functions associated with power over ethernet technology. For example, PoE controller 610 controls the power supplied to each of the plurality of jacks 129 (only a single jack 129 is shown in FIG. 7 for purposes of clarity).

Also included on circuit board 310 is a plurality of latching relays 615. In example embodiments, a latching relay 615 is provided for each of the plurality of jacks 129 (only a single latching relay 615 is shown in FIG. 7 for purposes of clarity). CPLD 194 controls two switches 620, 622 connected to latching relay 615 to control a state of latching relay 615. In the example shown, switches 620, 622 are Metal Oxide Field Effect Transistors (MOSFETs), although other types of switching devices can be used.

In the example shown, latching relay 615 is utilized to switch the output voltage polarity for jack 129. For example, latching relay 615 can be set in the position shown in FIG. 7 (e.g., a first state) to provide a first output voltage polarity on pairs 4/5, 7/8. As noted above, for 802.3af compliant devices, pairs 4/5 and pairs 7/8 can be of either polarity. For example, for the first state shown in FIG. 7, a positive voltage is provided on wires 632, 636, and a negative voltage is provided on wires 634, 638.

However, if a legacy device requiring opposite polarity is connected to jack 129, CPLD 194 is connected by wires 196, 198 to switches 620, 622. Switches 620, 622 cause latching relay 615 to switch as shown in FIG. 8 (e.g., a second state) so that the opposite or reverse output voltage polarity is provided to jack 129 on pairs 4/5, 7/8. For example, for the second state shown in FIG. 8, a negative voltage is provided on wires 634, 636, and a positive voltage is provided on wires 632, 638. The output voltage polarity can therefore be controlled (i.e., reversed) by controlling the state of latching relay 615.

In the example shown, a latching relay 615 is provided for each jack 129, and each latching relay 615 can be separately controlled by CPLD 194. For example, a state of each latching relay 615 can be individually controlled using a device connected to CPLD 194 through COM module 134. In this manner, legacy devices can be coupled to a power sourcing unit without requiring special patch cords to reverse polarity, since polarity reversal is handled by the power sourcing unit itself.

In the example shown, latching relays with part number AGN2103A03 manufactured by Aromat Corporation of New Providence, N.J. are used. Latching relays can be used so that if power to the unit is lost, the relays will remain in a given state once power is restored. In this manner, relays will not need to be reset upon power-up after a power loss. In other embodiments, other types of switches, such as non-latching relays or manual switches, can be used.

In an alternative embodiment, manual switches accessible to a user can be provided so that a user can manually select the voltage polarity for a given set of pins. For example, toggle switches can be provided adjacent to jacks 129 on a front face of chassis 105 of power sourcing unit 100 so that the user can manually select the output voltage polarity for a given jack 129 using the respective switch.

In another alternative embodiment, a status indicator such as an LED is provided adjacent to each jack 129 on a front of the power sourcing unit to indicate those jacks 129 for which the output voltage polarity has been reversed.

In another alternative embodiment, another relay for each jack 129 can be provided in a manner similar to latching relay 615 to switch transmit pairs 1/2 and receive pairs 3/6 for legacy devices that are reversed with respect to the 802.3af standard (e.g., legacy devices that require transmit pairs 3/6 and receive pairs 1/2). In this manner, legacy devices with reversed transmission paths can be accommodated without requiring special patch cords.

The above specification, examples and data provide a complete description of the manufacture and of the invention. Since many embodiments of the invention can be made without departing from the spirit and scope of the invention, the invention resides in the claims hereinafter appended.

What is claimed is:

1. A circuit board for a power sourcing unit for a power over ethernet system, the circuit board comprising:
a power over ethernet controller; and
a switch connected to the power over ethernet controller, wherein the switch switches a polarity of an output voltage controlled by the power over ethernet controller.

2. The circuit board of claim 1, further comprising a microcontroller to control a state of the switch.

3. The circuit board of claim 1, wherein the switch includes a first state for a first output voltage polarity, and a second state for a second output voltage polarity that is reversed from that of the first state.

4. The circuit board of claim 1, wherein the switch is a relay.

5. The circuit board of claim 4, wherein the relay is a latching relay.

6. The circuit board of claim 4, wherein the circuit board further comprises a plurality of relays, one relay for each jack of the power sourcing unit.

7. The circuit board of claim 1, further comprising a second switch connected to the power over ethernet controller, wherein the second switch switches transmit and receive pairs controlled by the power over ethernet controller.

8. A power sourcing unit for a power over ethernet system, the unit comprising:
a chassis;
a power supply positioned in the chassis;
a plurality of jacks; and
a printed circuit board coupled to the power supply and the plurality of jacks, the printed circuit board including a controller and a plurality of latching relays, at least one latching relay for each of the jacks, a state of each latching relay being controlled by the controller to switch a polarity of an output voltage from the power supply provided to a corresponding one of the jacks.

9. The power sourcing unit of claim 8, wherein the relay includes a first state for a first output voltage polarity, and a second state for a second output voltage polarity that is reversed from that of the first state.

10. The power sourcing unit of claim 8, wherein the state of each relay is controlled based on whether a device connected to a jack associated with a given relay is a compliant device or a non-compliant device.

11. The power sourcing unit of claim 10, wherein each relay has a first state for the compliant device and a second state for the non-compliant device.

12. The power sourcing unit of claim 11, wherein in the first state a voltage of positive polarity is provided to a first pair of a jack, and wherein in the second state a voltage of negative polarity is provided to the first pair of the jack.

13. The power sourcing unit of claim 8, further comprising a second plurality of latching relays, wherein each of the second plurality of latching relays switches transmit and receive pairs for one of the jacks.

14. A method for powering devices using an ethernet connection, the method comprising:
providing a power sourcing unit including a power over ethernet controller, and a switch connected to the power over ethernet controller; and
switching the switch to change a polarity of an output voltage controlled by the power over ethernet controller when a legacy device is connected to the power sourcing unit.

15. The method of claim 14, wherein the step of switching further comprises switching between a first state for a first output voltage polarity for a compliant device, and a second state for a second output voltage polarity for the legacy device that is reversed from that of the first state.

16. The method of claim 14, further comprising providing a latching relay for the switch.

17. The method of claim 14, further comprising providing a plurality of switches, one switch for each jack of the power sourcing unit.

18. The method of claim 14, further comprising:
providing a second switch connected to the power over ethernet controller; and
switching the second switch to switch transmit and receive pairs controlled by the power over ethernet controller.
